(19) United States
(12) Patent Application Publication
(10) Pub. No.: US 2026/0004603 A1
(43) Pub. Date: Jan. 1, 2026

(54) TABLE STRUCTURE RECOGNITION

(71) Applicant: Microsoft Technology Licensing, LLC, Redmond, WA (US)

(72) Inventors: Weihong LIN, Beijing (CN); Zheng SUN, Beijing (CN); Chixiang MA, Beijing (CN); Mingze LI, Shanghai (CN); Jiawei WANG, Beijing (CN); Lei SUN, Beijing (CN); Qiang HUO, Beijing (CN)

(73) Assignee: Microsoft Technology Licensing, LLC, Redmond, WA (US)

(21) Appl. No.: 18/880,667

(22) PCT Filed: Jul. 12, 2023
(86) PCT No.: PCT/US2023/027455

§ 371 Date: Jan. 2, 2025

(30) Foreign Application Priority Data
Aug. 3, 2022 (CN) 202210928214.X

(51) Int. Cl. G06V 30/412; G06V 30/413

(52) U.S. Cl. CPC G06V 30/412; G06V 30/413

(57) ABSTRACT

According to implementations of the present disclosure, a solution of table structure recognition is provided. A first set of reference points in the image including the table is determined based on a first feature map. The first feature map is generated from an image, and the first set of reference points are candidate points on the separation lines of a first type of the table. Based on at least a part of the first feature map and features of the first set of reference points, a set of predicted separation lines of the first type of the table can be determined in the image. The structure of the table is determined based at least on the set of predicted separation lines of the first type. In this way, the tables of various structures can be restored from the image.

### BACKGROUND

Tables provide a means of effectively representing and communicating structured data in many scenarios, such as scientific publications, financial statements, invoices, web pages, and so on. Due to the trend of digital transformation, it is necessary to digitize some paper forms. The electronization of a form requires that the structure of the form be recognized from the image including the form (also known as the form image). This makes the table structure recognition (TSR) technology an important research topic in the field of document understanding. Table structure recognition aims to identify the organizational structure of cells in a table image by extracting the span information of rows or columns.

### SUMMARY

According to implementations of the present disclosure, a solution for table structure identification is proposed. In this solution, a first set of reference points in the image including the table is determined based on a first feature map. The first feature map is generated from the image, and the first set of reference points are candidate points on separation lines of a first type of the table. Based on at least a part of the first feature map and features of the first set of reference points, a set of predicted separation lines of the first type for tables is determined in the image. The structure of the table is determined based at least on the set of predicted separation lines of the first type. The table structure recognition solution as proposed herein can be applied in a wide range of scenarios and is able to recognize the structures of various tables from images.

This Summary is provided to introduce the selection of objects in a simplified form, which will be further described in the specific implementations below. This part is not intended to identify the key features or main features of the subject matter to be protected, nor to limit the scope of the subject matter to be protected.

### BRIEF DESCRIPTION OF DRAWINGS

FIG. 1 shows a block diagram of an example environment in which various implementations of the present disclosure can be implemented;

FIG. 2 illustrates an example architecture of a form recognition model implemented in accordance with some implementations of the present disclosure;

FIG. 3A shows an example architecture of a separation line prediction module in a table recognition model implemented according to some implementations of the present disclosure;

FIG. 3B shows an example architecture of a decoder in a divider prediction module implemented in accordance with some implementations of the present disclosure;

FIG. 4 shows an example architecture of a feature extraction module in a form recognition model implemented according to some implementations of the present disclosure;

FIG. 5 shows an example architecture of a cell processing module in a table recognition model implemented in accordance with some implementations of the present disclosure;

FIG. 6 shows a flowchart of a process of identifying tabular results according to some implementations of the present disclosure; and

FIG. 7 shows a schematic block diagram of an electronic device capable of implementing various implementations of the present disclosure.

### DETAILED DESCRIPTIONS

Implementations of the present disclosure will now be discussed with reference to a number of example implementations. It is to be understood that these implementations are discussed only to enable those skilled in the art to better understand and thus implement the disclosure, rather than imply any limitation on the scope of the disclosure.

As used herein, the term “comprises” and its variants are to be interpreted as an open term meaning “comprises but is not limited to”. The term “based on” is to be read as “base at least in part on”. The terms “an implementation” and “one implementation” should be interpreted as “at least one implementation”. The term “another implementation” should be interpreted as “at least one further implementation”. The terms “first”, “second”, and the like may refer to different or identical objects. Other explicit and implicit definitions may also be comprised below.

As used herein, a set of elements, element set, or similar expressions may comprise zero, one, or a plurality of the elements. This set of elements can be ordered or unordered. For example, a “set of separation lines” can comprise zero, one or more separation lines. As used in text, an element sequence or similar expression can comprise one or more such elements, and the elements in the sequence are ordered.

As used herein, the term “separation line” is used to separate cells or areas in a table. Separation lines can comprise row separation lines separating different rows or column separation lines separating different columns. In this context, it is not excluded that the separation line is used to separate other types of elements in the table. Although called a “line,” a “separation line” can have a certain width. In addition, the separation line can be explicit, visible, or implicit, invisible in the image.

As used herein, the term “predetermined direction of the separation line” refers to the possible or general direction in which the separation line extends. It is to be understood that the predetermined direction of the separation line is not necessarily the actual direction of the separation line in the image, because the table in the image may be deformed or tilted. As used herein, the term “reference point” may comprise one or more points.

As used herein, the term “model” can learn the association between corresponding inputs and outputs from training data, so that corresponding outputs can be generated for a given input after training. The model generation can be based on machine learning technology. Deep learning (DL) is a machine learning algorithm that processes inputs and provides corresponding outputs by using multi-layer processing units. The neural network model is an example of a model based on deep learning. In this paper, “model” can also be called “machine learning model”, “learning model”, “machine learning network” or “learning network”, and these terms are used interchangeably in this paper.

Generally machine learning can comprise three stages, namely training stage, testing stage and use stage (also known as inference stage). In the training phase, the given model can be trained with a large number of training data, and iterate continuously until the model can obtain consistent inference that meets the expected goal from the training data. Through training, the model can be considered to be able to learn the association between input and output from training data (also known as input to output mapping). The parameter values of the trained model are determined. In the test phase, the test input is applied to the trained model to test whether the model can provide correct output, so as to determine the performance of the model. In the application phase (also known as the inference phase), the model can be used to process the actual input and determine the corresponding output based on the parameter values obtained from the training.

### Sample Environment

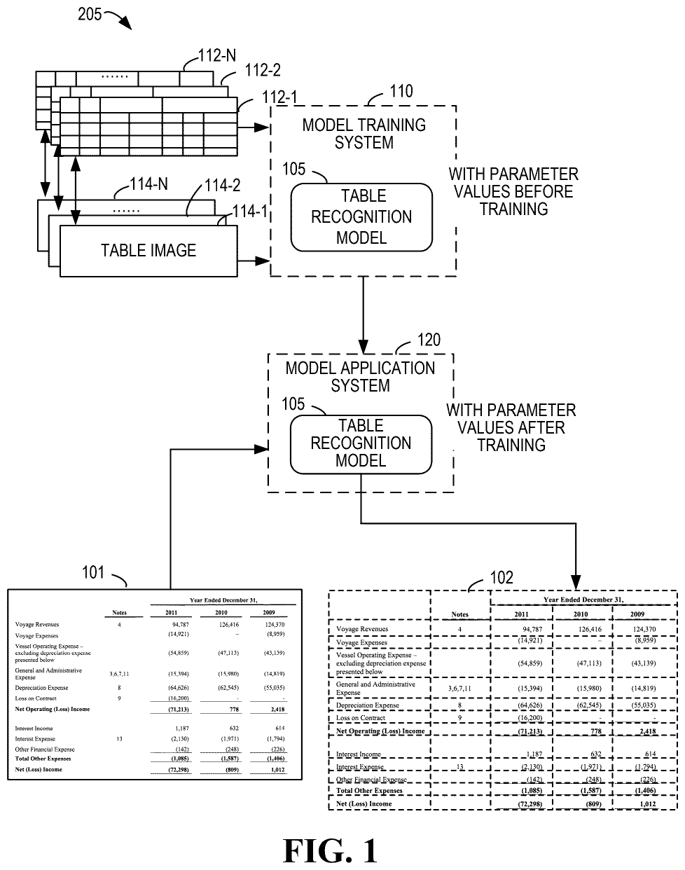

FIG. 1 shows a block diagram of an example environment 100 in which various implementations of the present disclosure can be implemented. In environment 100, it is desirable to train and use such a form recognition model 105 for at least recognizing the structure of a form in an image.

As shown in FIG. 1, the environment 100 comprises a model training system 110 and a model application system 120. In the example implementation of FIG. 1, the model training system 110 is used to train the form recognition model 105 using training data. The training data can comprise a plurality of table images 114-1, 114-2, . . . , 114-N, and the structure data 112-1, 112-2, . . . , 112-N of the tables therein, where N is an integer greater than or equal to 1. For the sake of discussion, table images are collectively or individually referred to as table images 114, and structural data is or individually referred to as structural data 112.

Prior to training, the parameter values of the form recognition model 105 can be initialized, or the pre-trained parameter values can be obtained through the pre training process. Through the training process, the parameter values of the form recognition model 105 are updated and adjusted. After the training, the form recognition model 105 has the trained parameter values. Based on such parameter values, the form recognition model 105 can at least recognize a form structure from an image.

In FIG. 1, the model application system 120 receives an input image 101, also known as an image to be recognized, including a table. The image 101 may be any type of image, and the scope of the present disclosure is not limited in this regard. For example, the image 101 may be captured by a camera or may be converted from other types of files. The image 101 may be a portion of another larger image including a table. The model application system 120 is used to perform table structure recognition on the image 101 using the trained table recognition model 105 to obtain the recognition result 102. The recognition result 102 at least comprises the structure of the table in the image 101, such as the layout of the cells in the table, the coordinates of each cell, and so on. In some implementations, the recognition result 102 may also comprise the type of content filled in the cell, such as a header.

In FIG. 1, the model training system 110 and the model application system 120 may be any system with computing capability, such as various computing devices/systems, terminal devices, servers, and the like. Terminal equipment can be any type of mobile terminal, fixed terminal or portable terminal, including mobile phone, desktop computer, laptop computer, netbook computer, tablet computer, media computer, multimedia tablet, or any combination of the foregoing, including accessories and peripherals of these equipment or any combination thereof. Servers comprise but are not limited to mainframe, edge computing nodes, computing devices in cloud environment, etc.

It is to be understood that the components and arrangements in the environment shown in FIG. 1 are only examples, and the computing system suitable for implementing the example implementation described in the present disclosure may comprise one or more different components, other components and/or different arrangements. For example, although shown as separate, the model training system 110 and the model application system 120 may be integrated in the same system or device. The implementation of this disclosure is not limited in this respect.

It is to be understood that the structure and function of each element in the environment 100 are described for illustrative purposes only, without implying any limitation on the scope of the present disclosure. In addition, although the text in the table of image 101 is in English, it is only illustrative and is not intended to limit the scope of this disclosure. Implementations of the present disclosure can be used to identify the structure of tables in any language.

### Working Principle and Sample Architecture

As briefly mentioned above, table structure recognition has important applications. On the one hand, tables have complex and varied structures. For example, a table may comprise unbounded cells, large blank areas, empty or large span cells, and so on. On the other hand, the capture process of the table image may cause geometric deformation or even bending of the table in the image. In view of this, the task of table structure identification is very challenging,

A table structure recognition solution based on deep learning has been used to recognize tables with complex structures and different styles. However, some of these solutions cannot be directly applied to geometric deformation or even bending tables, which often appear in images captured by cameras. Other solution cannot recognize tables without boundaries.

Example implementations of the present disclosure propose a solution for table structure recognition. According to various implementations of the present disclosure, a set of reference points in an image is determined based on a feature map for separation lines of at least one type. The feature map is generated from an image including a table, and these reference points are candidate points of the separation lines this type in the table. This type of separation lines can be row separation lines or column separation lines. Based on the feature map and the features of these reference points, predicted separation lines of this type of the table is determined in the image. The structure of the table is determined based at least on these predicted separation lines.

In implementations of the present disclosure, the reference points that may be located on the separation lines are first predicted for the separation lines, and then the points on the separation lines are detected based on the reference points, thereby predicting the separation lines. In this way, the table structure recognition scheme of the present disclosure has wide applicability and high accuracy for various tables. Recognition can be done on not only deformed or even curved tables, but also other tables of various styles such as tables with unbounded cells, large blank areas, empty cells, etc.

Some example implementations of the present disclosure will be described in more detail below with reference to the accompanying drawings.

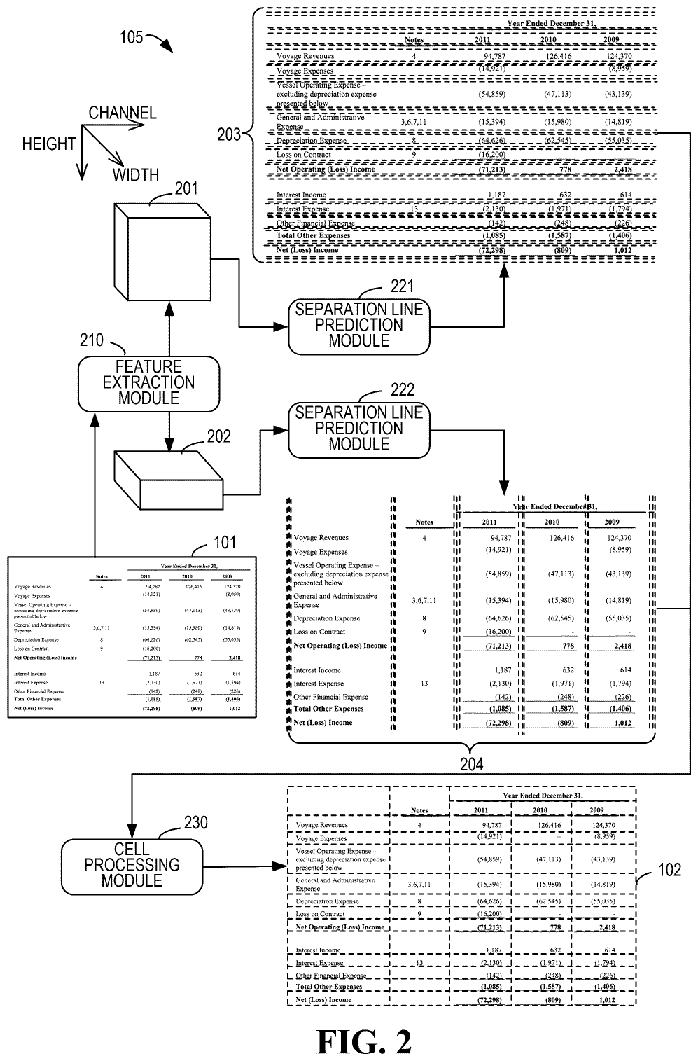

FIG. 2 shows an example architecture of a table recognition model 105 implemented in accordance with some of the present disclosure. In general, the table recognition model 105 comprises at least one of the feature extraction module 210, the separation line prediction module 221, and the separation line prediction module 222, and the cell processing module 230.

In implementations of the present disclosure, it is assumed that the size of the input image 101 is H×W, that is, the image 101 has W pixels in the width direction and H pixels in the height direction. The feature extraction module 210 is used to generate at least one feature map from the image 101. FIG. 2 shows a feature map 201 for predicting row separation lines and a feature map 202 for predicting column separation lines. As an example only, the size of feature map 201 can be

$$\frac{H}{4} \times \frac{W}{32} \times C ,$$

and the size of feature map 201 can be

$$\frac{H}{32} \times \frac{W}{4} \times C ,$$

where

C is the channel dimension. It is to be understood that the dimensions of the above feature maps are for illustrative purposes only and are not intended to limit the scope of the present disclosure. In the present disclosure, feature FIGS. 201 and 202 may have any suitable size.

Although two feature maps are shown in FIG. 2 for predicting row separation lines and column separation lines respectively, this is only example without suggesting any limitations on the scope of the present disclosure. In some implementations, the feature extraction module 210 may generate the same feature map for predicting row separation lines and column separation lines.

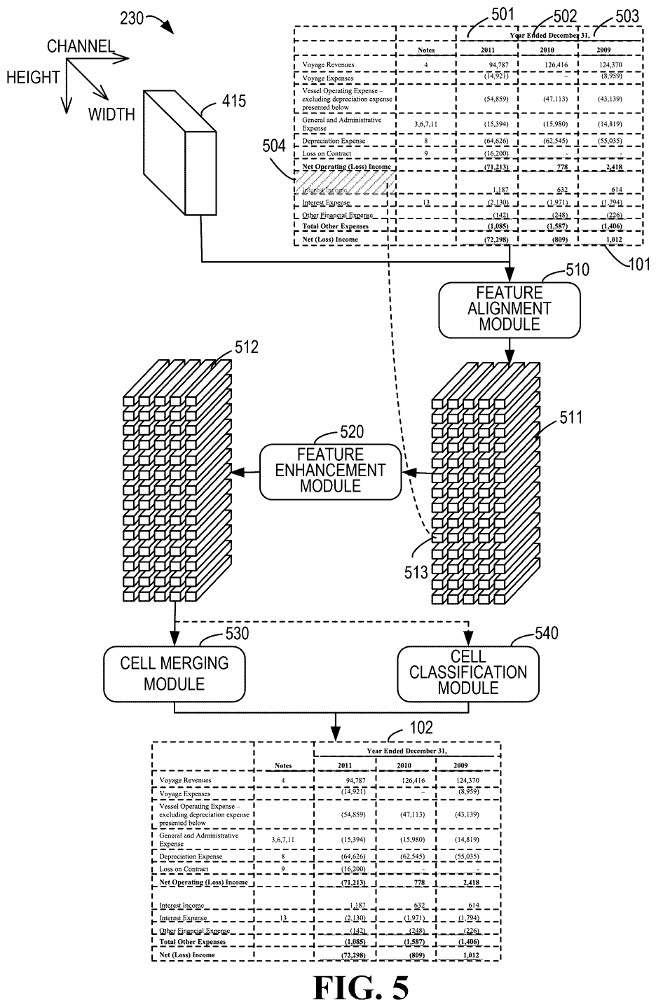

The feature extraction module 210 may have any suitable network to generate a feature map from the image 101. In some implementations, the feature extraction module 210 can propagate the context information in the image in the feature map so that the features in the generated feature map are context enhanced. This context enhanced feature can reflect the spatial information in the image 101. Such an implementation will be described in detail below with reference to FIG. 5.

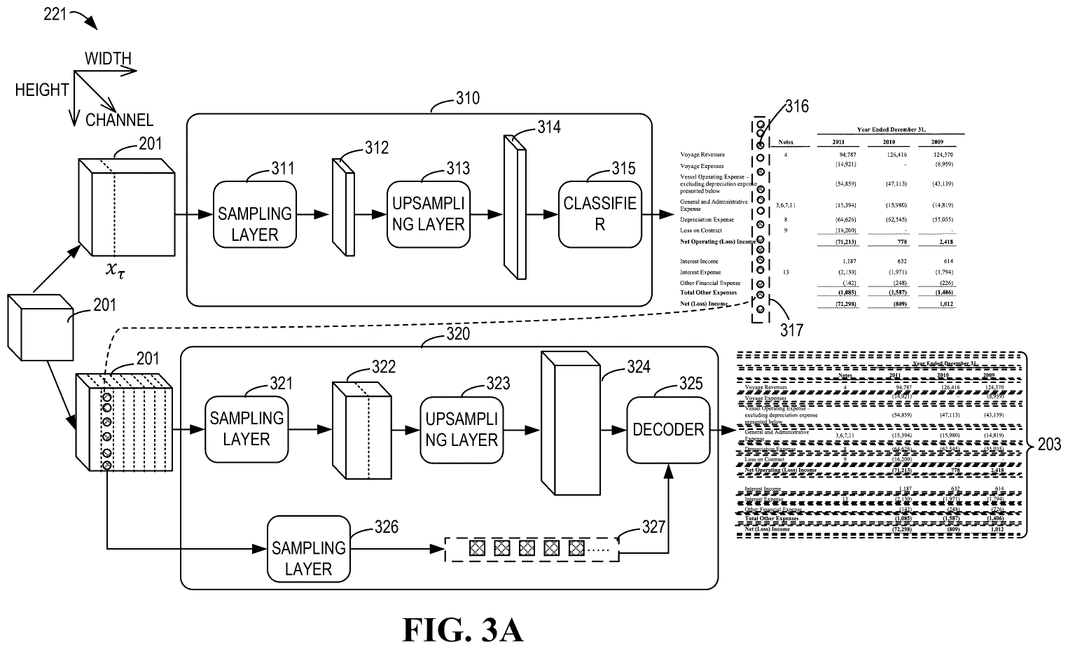

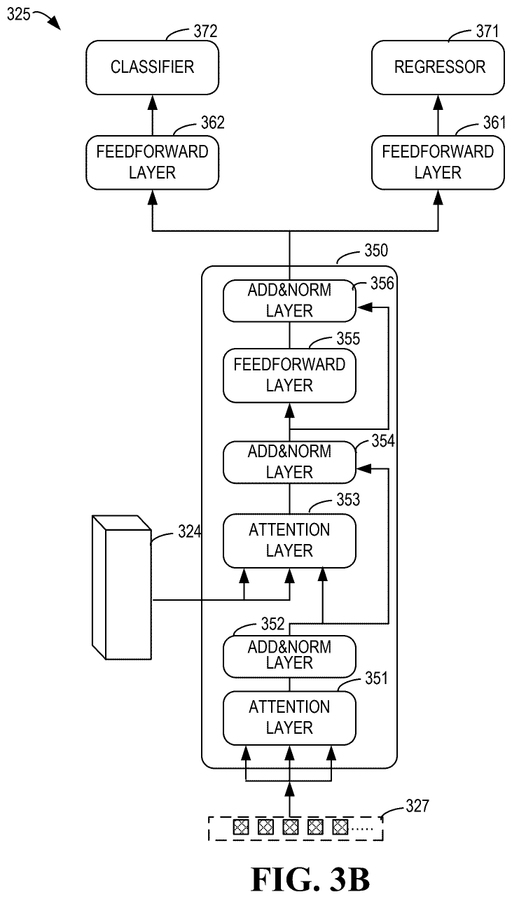

The separation line prediction modules 221 and 222 are each used to determine a set of reference points based on the received feature map. These reference points are candidate points of a certain type of separation lines in the table; and a set of predicted separation lines of this type is determined in the image 101 based on at least a part of the feature map and the features of these reference points. As shown in FIG. 2, the feature map 201 is input to the separation line prediction module 221 to predict the row separation lines of the table. The separation line prediction module 221 determines a set of predicted row separation lines 203 for a table in the image 101 based on the feature map 201. The feature map 202 is input to the separation line prediction module 222 for predicting the column separation lines of the table. The separation line prediction module 222 determines a set of predicted column separation lines 204 for a table in the image 101 based on the feature map 202. An example of the divider prediction module will be described below with reference to FIGS. 3A and 3B.

The predicted row separation lines 203 and the predicted column separation lines 204 are input to the cell processing module 230. The cell processing module 220 generates the recognition result 102 based at least on the predicted row separation lines 203 and the predicted column separation lines 204. The recognition result 102 at least comprises the structure of the table in the image 101, that is, the layout of the cells. An example of a cell processing module will be described below with reference to FIG. 5.

In the example architecture of FIG. 2, two separation line prediction modules are used to predict separation lines of two types, namely, row separation lines and column separation lines. It is to be understood that this is only example without suggesting any limitations on the scope of the present disclosure. In some implementations, it is possible to predate separation lines of one type, such as row separation lines or column separation lines. In such implementations, the table recognition model 105 may comprise only one separation line prediction module. predicted separation lines of another type(s) can be determined in any other suitable manner. The cell processing module 230 may determine the structure of a table based on one type of predicted separation line determined by the separation line prediction module and another type of separation line obtained in other ways.

Alternatively, in some specific scenarios, it may not be necessary to identify separation lines of another type, or separation lines of another type do not exist in the table. In such a scenario, the cell processing module 230 may determine the structure of the table based on the predicted separation lines as determined by the separation line module.

### Prediction of Separation Lines Based on Reference Points

Taking the separation line prediction module 221 for predicting the row separation line as an example, the following describes an example of separation line prediction based on reference points. FIG. 3A shows an example architecture of the separation line prediction module 221 implemented in accordance with some of the present disclosure. In general, the separation line prediction module 221 comprises a reference point detection module 310 and a separation line regression module 320.

The reference point detection module 310 is used to determine a set of reference points 316 in the image 101 based on the feature map 201. The reference points 316 are potentially located on row separation lines of the table. In other words, this set of reference points 316 are candidates on the row separation lines of the table. In the context, this set of reference points 316 are also referred to as row reference points 316.

In order to predict all row separation lines of a table as accurately as possible, in some implementations, the row reference points can be distributed in a direction perpendicular to a predetermined direction of the row separation lines. As to the image 101, the predetermined direction of the line separation lines is the width direction of the image 101, and the direction perpendicular to the predetermined direction of the line separation lines is the height direction of the image 101. It is to be understood that the predetermined direction of the column separation lines is the height direction of the image 101, and the direction perpendicular to the predetermined direction of the column separation lines is the width direction of the image 101.

Further, in some implementations, the row reference points may be located at the same position in the predetermined direction of the row separation lines, such as the row reference points 316 in FIG. 3A. Hereinafter, the position of the row reference points 316 in the width direction is indicated as x_{τ}, which can be W/4 for example. In this implementation, the row reference points can be determined in a simple and convenient way. However, it is to be understood that the distribution of the row reference points shown in FIG. 3A according to 316 is only an example. In other implementations, the row reference points can be distributed across the height direction, but at different locations in the width direction. For example, the reference point of the upper part can be located at x_{τ}=W/4, while the reference point of the lower part can be located at x_{τ}=W/8.

In order to obtain row reference points at the same position in the width direction, such as those shown in FIG. 3A, the reference point detection module 310 can extract features of the reference pixel block 317 of the image 101 from the feature map 201. The reference pixel block 317 is sampled in a direction perpendicular to the predetermined direction of the row separation line (i.e., the height direction). For example, the reference pixel block 317 may comprise all pixels at x_{τ}. The reference point detection module 310 may further select a set of pixels in the reference pixel block 317 as the row reference points 316 based on the features of the reference pixel block 317.

In the example of FIG. 3A, the sampling layer 311 extracts the feature sub-map 312 from the feature map 201, which comprises features of pixels in the width direction position. The size of the feature map 201 in the width dimension is smaller than the image 101. In order to extract the feature sub-map 312, the sampling layer 311 can compute the features in the feature sub-map 312 based on the feature map 201 by interpolation. The upsampling layer 313 upsamples the feature sub-map 312 to obtain the feature sub-map 314. The feature sub-map 314 has the same size as the image 101 in the height dimension. Merely as an example, if the size of feature map 201 is

$$\frac{H}{4} \times \frac{W}{32} \times C ,$$

the size of feature sub-map 312 can be

$$\frac{H}{4} \times C ,$$

and the size of feature sub-map 314 can be H×C.

The feature sub-maps 314 are fed into the classifier 315. The classifier 315 predicts the probability p that each pixel in the reference pixel block 317 is located on row separation lines based on the feature sub-map 314. The pixels whose probability p is greater than the threshold value can be determined as the row reference points 316, or a certain number of pixels ranking top according to probability p can be determined as the row reference point. The classifier 315 may be implemented in any suitable network. For example, classifier 315 may comprise a full connection layer and a sigmoid activation function.

In the implementation of FIG. 3A, the feature map 201 is smaller than the image 101 in width and height dimensions. In this implementation, the computational effort can be reduced by processing smaller feature maps. Alternatively, in some implementations, the feature map 201 may be up-sampled to obtain a transformed feature map with the same width and height dimensions as the image 101. In this implementation, the reference point detection module 310 can directly extract the features of the pixels at x_{τ} in the transformed feature map as the features of the reference pixel block, and feed the features of the pixels at x_{τ} the transformed feature map to the classifier 315 to select row reference points from the reference pixel block.

The separation line regression module 320 is used to determine a set of predicted row separation lines 203 of a table based on at least a part of the feature map 201 and the features of the row reference points 316. The sampling layer 326 extracts the features of the row reference points 316 from the feature map 201. The sampling layer 326 outputs feature sub-maps 327, in which each feature represents a row reference point. In some implementations, the features of the reference points 316 and the feature map 201 may be fed to the decoder 325 to determine the position of the line separation line based on the position of the reference points 316.

The proportion of separation lines in the whole table is relatively small. In addition, although there may be distortion or deformation, a certain number of points can roughly determine a separation line for the table. In view of this, it is not necessary to consider the features of the whole image when determining the separation line. In some implementations, features of a part of the image 101 may be extracted from the feature map 201. The features of this part and the features of the reference points 316 can be fed to the decoder 325 to determine the position of the line separation lines. In this implementation, the feature map 201 is sampled. The part of the image whose features are extracted is also called “sampled part”, and the features of the sampled part are called “sampled features”. The pixels in the sampled part can be considered as sampling points.

The feature map 201 may be sampled in any suitable manner. For example, the pixels in the image 101 or the feature map 201 may be randomly sampled, and the features of the randomly sampled pixels may be extracted. As another example, deformable convolution can be used to predict which pixels are sampled for each reference point, and the features of these pixels can be extracted from the feature map 201.

The predetermined direction of the row separation lines is the width direction of the image. Although there may be distortion or deformation, a certain number of points along the width direction can roughly determine the row separation lines. Therefore, in determining the row separation line, not all the pixels in the width direction have to be necessarily considered. In view of this, in determining the row separation lines, sampling can be done in the width direction at x₁, x₂, x₂, . . . , x_{K}, totally K positions where K is an integer greater than 1.

In view of this, in some implementations, features of K pixel blocks can be extracted from the feature map 201. K pixel blocks are spaced along the width direction, and each pixel block extends in the height direction. That is, the features of the pixel blocks at x₁, x₂, x₂, . . . , x_{K} can be extracted from the feature map 201 and spliced into a feature sub-map. Each pixel block comprises all pixels at xᵢ, where i=1, . . . , K. Merely as an example and without suggesting any limitations on the scope of the present disclosure, K can be 15 and

$${x}_{i} = \frac{W}{16} \times i .$$

In the example of FIG. 3A, the sampling layer 321 extracts the features of the pixel blocks at x₁, x₂, x₂, . . . , x_{K} in the width direction from the feature map 201 by interpolation and splices them into a feature sub-map 322. The upsampling layer 323 upsamples the feature sub-map 322 to obtain the spliced feature sub-map 324. The feature sub-map 324 has the same size as the image 101 in the height dimension. As an example only, when the size of feature map 201 is

$$\frac{H}{4} \times K \times C ,$$

the size of feature sub-map 322 can be

$$\frac{H}{4} \times K \times C ,$$

and the size of feature sub-map 324 can be H×K×C.

In the implementation of FIG. 3A, the feature map 201 is smaller than the image 101 in width and height dimensions. As described with respect to the reference point detection module 310, in some implementations, the feature map 201 may be upsampled to obtain a transformed feature map that is the same as the image 101 in width and height dimensions. The separation line regression module 320 can directly extract the features of the pixels at x₁, x₂, x₂, . . . , x_{K} in the transformed feature map and splice them into a feature sub-map which is fed to the decoder 325.

The sampled feature (in the example of FIG. 3A, the feature sub-map 324) and the feature sub-maps 327 of the row reference points 316 are fed to the decoder 325. The decoder 325 determines the predicted pixel in the image 101 at the row separation line based on the sampled features and the features of the row reference points 316. In the example of FIG. 3A, the decoder 325 determines the predicted pixels located at the row separation lines in the image 101 based on the features of the pixel block at x₁, x₂, x₂, . . . , x_{K} and the features of the row reference points 316. Based on the position of the predicted pixel in the image 101, the predicted row separation lines 203 can be determined. The determination of row separation lines will be described below with reference to FIG. 3B.

In this implementation, only a part of the feature map is used to update the feature of the reference points by sampling. In this way, the inference time of the model can be significantly reduced without reducing the accuracy.

The decoder 325 predicts line separation lines based on the features of the sampled pixel blocks and the features of the row reference points. The decoder 325 may be implemented in any suitable network, such as a cyclic neural network (RNN). In some implementations, the decoder 325 may be implemented using an attention mechanism. FIG. 3B shows an example architecture of a decoder 325 according to some implementations of the present disclosure.

In this example, the decoder 325 generally comprises a unit 350 that repeats Nx (which is an integer greater than or equal to 1, for example, 3) times, a feedforward layer 361, a classifier 371, a feedforward layer 362, a classifier 372, and the like. The unit 350 further comprises an attention layer 351, an addition and normalization layer 352, an attention layer 353, an addition and normalization layer 354, a feedforward layer 355, and an addition and normalization layer 356 arranged from the input to the output. It is to be understood that the structure of the decoder 325 in FIG. 3B is only example without suggesting any limitations on the scope of the present disclosure. The decoder 325 may also comprise other layers or structures. For example, the decoder 325 also comprises position embedding input to the attention layers 351 and 353.

The features of the individual row reference points 316 in the feature sub-map 327 are used as queries in the attention mechanism. The attention layer 351 applies self-attention to the feature sub-maps 327, and the output feature map is input to the attention layer 353 as a query after being processed by the addition and normalization (add & norm) layer 352. Attention layer 353 realizes cross-attention. The feature sub-map 324 including the features of K pixel blocks is input to the attention layer 353 and is used as keys and values in the cross-attention mechanism.

After processing of the subsequent layers in unit 350, the features of the row reference points 316 are updated. The updated features of each row reference point reflect the correlation between that row reference point and each pixel in the sampled part (K pixel blocks in the example of FIG. 3). Specifically, according to the correlation between the features of each pixel in the sampled part and the features of the reference point, the features of each pixel in the sampled part are weighted and summed to obtain the updated features of the reference point.

The updated features of the row reference points 316 are fed to the feedforward layer 362, and then to the classifier 372. Classifier 372 is used to determine whether each row reference point is on the row separation line of the table. Assuming there are Q row reference points, the classifier 372 outputs Q classification results to indicate whether the Q row reference points are on the row separation line.

The updated features of the row reference points 316 are also fed to the feedforward layer 361, and then to the regressor 371. When a line is used to represent the row separation line, for each row reference point on the row separation line determined by the classifier 372, the regression 371 predicts the coordinates of K height directions to represent the coordinates of the points at x₁, x₂, x₂, . . . , X_{K} on the row separation line in the width direction corresponding to the row reference point. According to the coordinates of the K height directions, the row separation line corresponding to the reference point can be determined.

The separation lines of a table may sometimes be wide. In view of this, in some implementations, a plurality of lines can be used to represent row separation lines. For example, in the example of FIG. 3A, an upper boundary line, a centerline and a lower boundary line are used to represent a row separation line. In this implementation, for each row reference point determined by the classifier 372 as being on the row separation line, the regression 371 predicts 3K height direction coordinates to represent the coordinates of the point at x₁, x₂, x₂, . . . , X_{K} on the row separation line in the width direction corresponding to the row reference point. According to the coordinates of the 3K height directions, it is possible to determine the upper boundary line, centerline and lower boundary line related to the line separation line corresponding to the reference point. The centerline can be used as the predicted row separation line.

In this implementation, the features of the query used as the attention mechanism have a clear practical significance, that is, the features of the pixels that may be located on the separation line. On this basis, the predicted separation line obtained by regression can be more accurate.

Example implementations of predicting row separation lines based on row reference points have been described with reference to FIGS. 3A and 3B. A similar process can be applied to the prediction of column separation lines and separation lines of other possible types.

For example, in the predicted column separation lines, the column reference points are distributed along the width direction of the image 101. The reference pixel block for selecting the column reference point may be located at y_{τ} which can be H/4, for example.

In the implementation described above, each separation line is represented by K or 3K points. It is to be understood that this is only example without suggesting any limitations on the scope of the present disclosure. In implementations of the present disclosure, the separation line may be represented in any suitable manner. For example, in some implementations, the separation line can also be represented by the parameters of the curve equation. Accordingly, the regression 371 may represent the parameters of the curve equation of the separation line.

### Context Enhanced Feature Map

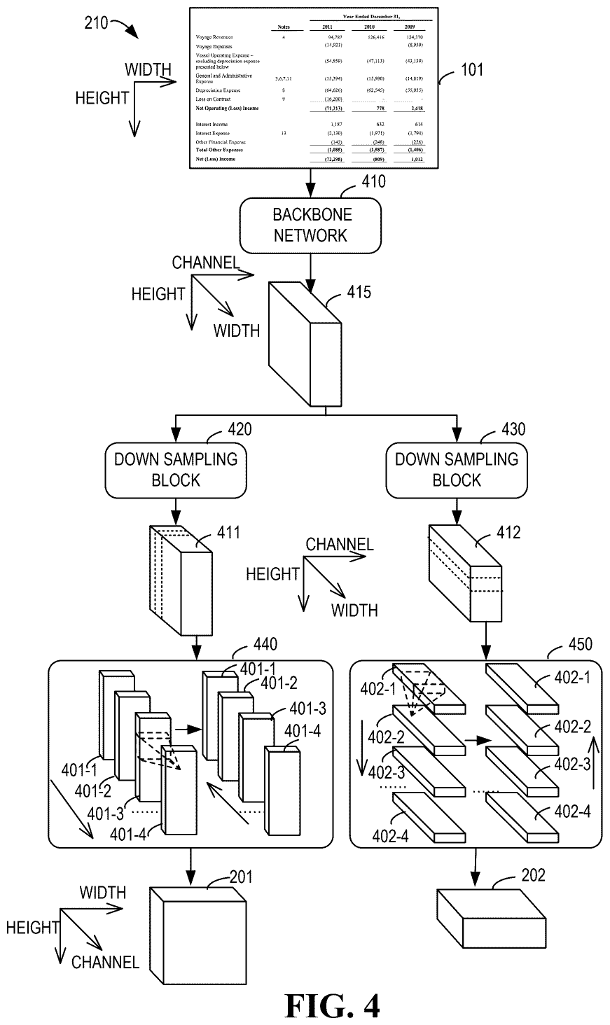

As briefly mentioned above with reference to FIG. 2, in some implementations, one or both of the feature maps 201 and 202 can be context enhanced. FIG. 4 shows an example architecture of a feature extraction module 210 implemented in accordance with some of the present disclosure. In the example of FIG. 4, the feature map 201 for predicting row separation lines and the feature map 202 for predicting column separation lines are context enhanced.

As shown in FIG. 4, the backbone network 410 generates a feature map 415 from the image 101. Merely as an example without suggesting any limitations on the scope of the present disclosure, the dimensions of feature map 415 are

$$\frac{H}{4} \times \frac{W}{4} \times C ,$$

for example. Backbone network 410 may be implemented by any suitable network, such as a residual network. The implementation of this disclosure is not limited in this respect.

In the row separation line prediction branch, the feature map 415 is downsampled to generate the feature map 411. Considering that the feature map 411 is used to predict the row separation lines and that the predetermined direction of the row separation lines is the width direction, the feature map 411 is down sampled in the width direction relative to the feature map 415. Merely as an example without suggesting any limitations on the scope of the present disclosure, in the case where the size of feature map 415 is

$$\frac{H}{4} \times \frac{W}{4} \times C ,$$

for example, the size of feature map 411 may be

$$\frac{H}{4} \times \frac{W}{32} \times C .$$

In some implementations, a convolution layer may exist before the down sampling block 420, and convolution may be performed on the feature map 415. The down sampling block 420 may be repeated three times. For example, the down sampling block 420 may comprise a maximum pooling layer, a convolution layer, and an activation function layer.

The feature map 411 is fed to the feature enhancement module 440. The row separation lines extend roughly along the width direction of the image 101, so it is necessary to propagate the context information in the width direction. Accordingly, in the feature enhancement module 440, the feature map 411 is divided into a series of feature sub-maps 401-1, 401-2, 401-3, 401-4, etc. along the predetermined direction (i.e., the width direction) of the line separation line, which are also collectively or individually referred to as the feature sub-map 401. Feature sub-maps can be regarded as feature slices. As an example, when the size of the feature map 411 is

$$\frac{H}{4} \times \frac{W}{32} \times C ,$$

the feature map 411 can be divided into

$$\frac{W}{32}$$

feature sub-maps, each of which has a size of

$$\frac{H}{4} \times C .$$

A series of feature sub-maps 401 can be updated by performing feature transformation on a series of feature sub-maps 401 in order from left to right and from right to left. The updated series of feature sub-maps 401 are combined into feature map 201. Each feature sub-map 401 is input to the feature transformation layer. The transformed features of the feature sub-map are used to update the next feature sub-map. For example, the transformed feature can be combined with the next feature sub-map by adding each element to update the next feature sub-map. Feature transformation is used to extract context information, and can comprise, for example, convolution operation, attention mechanism, etc. When the feature transformation is a convolution operation, the feature enhancement module 440 may be a spatial convolutional neural network (SCNN).

Considering left to right as an example, the feature sub-map 401-1 is input to the feature transformation layer. The transformed features of the feature sub-map 401-1 are used to update the feature sub-map 401-2 that follows in a left to right direction. For example, the transformed feature and feature sub-map 401-2 are added element by element as the updated feature sub-map 401-2. The updated feature sub-map 401-2 is input to the feature transformation layer. The transformed features of the updated feature sub-map 401-2 are used to update the subsequent feature sub-map 401-3. And so on, to the feature sub-map on the far right. A series of feature sub-maps 401 may be updated in a similar manner from right to left.

In some implementations, the updates from left to right and updates from right to left can be cascaded. For example, the feature sub-map 401 can be updated from left to right from the leftmost feature sub-map until the rightmost feature sub-map is updated. Then update the feature sub-map from right to left from the updated rightmost feature sub-map until the leftmost feature sub-map is updated. A series of feature sub-maps 401 so updated are combined into feature map 201.

Alternatively, in some implementations, left-to-right updates and right-to-left updates may be separate. The feature sub-map 401 can be updated from left to right from the leftmost feature sub-map until the rightmost feature sub-map is updated. The feature sub-map can be updated from right to left from the rightmost feature sub-map until the leftmost feature sub-map is updated. The feature sub-map 401 updated from right to left and the feature sub-map 401 updated from left to right can be fused into the final updated feature sub-map 401, for example, by adding each pixel. The finally updated series of feature sub-maps 401 are combined into feature map 201.

In the column separation line prediction branch, the feature map 415 is down sampled to generate the feature map 412. Considering that the feature map 412 is used to predict the column separation lines and that the predetermined direction of the column separation lines is the height direction, the feature map 412 is down sampled in the height direction relative to the feature map 415. Merely as an example without suggesting any limitations on the scope of the present disclosure, in the case where the size of feature map 415 is

$$\frac{H}{4} \times \frac{W}{4} \times C ,$$

for example, the size of feature map 412 may be

$$\frac{H}{32} \times \frac{W}{4} \times C .$$

In some implementations, a convolution layer may exist before the down sampling block 430 to perform convolution on the feature map 415. The down sampling block 430 may be repeated three times. For example, the down sampling block 430 may comprise a maximum pooling layer, a convolution layer, and an activation function layer.

The feature map 412 is fed to the feature enhancement module 450. The column separation line extends roughly along the height direction of the image 101, so it is necessary to propagate the context information in the height direction. Accordingly, in the feature enhancement module 450, the feature map 412 is divided into a series of feature sub-maps 402-1, 402-2, 402-3, 402-4, etc. along the predetermined direction (i.e., the height direction) of the column separation line, which is also collectively or individually referred to as the feature sub-map 402. As an example, when the size of the feature map 412 is

$$\frac{H}{32} \times \frac{W}{4} \times C ,$$

the feature map 412 can be divided into

$$\frac{H}{32}$$

feature sub-maps, and the size of each feature sub-map is

$$\frac{W}{4} \times C .$$

A series of feature sub-maps 402 may be updated by performing feature transformation on the series of feature sub-maps 402 from top to bottom and from bottom to top. The updated series of feature sub-maps 402 are combined into a feature map 202. Each feature sub-map 402 is input to the feature transformation layer. The transformed features of the feature sub-map are used to update the next feature sub-map. For example, the transformed feature can be combined with the next feature sub-map by adding each element to update the next feature sub-map. Similar to the feature enhancement module 440, the feature transformation may comprise a convolution operation, an attention mechanism, and the like. Where the feature transformation is a convolution operation, the feature enhancement module 450 may be SCNN.

Considering the order from top to down as an example, the feature sub-map 402-1 is input to the feature transformation layer. The transformed features of feature sub-map 402-1 are used to update the feature sub-map 402-2 that follows in an upward downward direction. For example, the transformed feature and feature sub-map 402-2 are added element by element as the updated feature sub-map 402-2. The updated feature sub-map 402-2 is input to the feature transformation layer. The transformed features of the updated feature sub-map 402-2 are used to update the subsequent feature sub-map 402-3. This continues until the lowest feature sub-map. A series of feature sub-maps 402 may be updated in a similar manner from bottom to top.

In some implementations, updates from top to bottom and updates from bottom to top can be cascaded. For example, the feature sub-map 401 can be updated from top to bottom from the top feature sub-map until the bottom feature sub-map is updated. Then update the feature sub-map from the bottom to the top from the updated feature sub-map until the top feature sub-map is updated. A series of feature sub-maps 402 thus updated are combined into feature map 202.

Alternatively, in some implementations, the top-down update and the bottom-up update may be separate. The feature sub-map 402 can be updated from top to bottom from the top feature sub-map until the bottom feature sub-map is updated. The feature sub-map can be updated from the bottom to the top until the top feature sub-map is updated. The feature sub-map 402 updated from top to bottom and the feature sub-map 402 updated from bottom to top can be fused into the final updated feature sub-map 402, for example, by adding each pixel. The finally updated series of feature sub-maps 402 are combined into feature map 202.

In the example architecture shown in FIG. 4, a context enhanced feature map is implemented. This context enhanced feature can use spatial information to achieve better representation. Applying this context enhanced feature to the separation line prediction module facilities more accurate prediction of row separation lines by using the context information across the width direction; likewise, the prediction of column separation lines is more precise by using the context information across the height direction.

In the examples as described above, the predetermined direction of the row separation line is the width direction, and the predetermined direction of the column separation line is the height direction. This is merely illustrative without suggesting any limitations on the scope of the present disclosure. The table can have any orientation in the image, such as vertical and inclined. For example, the predetermined direction of the row separation lines may be the height direction, and the predetermined direction of the column separation lines may be the width direction. For another example, the predetermined direction of the row separation lines can be at an angle with the width direction, and the predetermined direction of the column separation lines can be at an angle with the height direction. In addition, in some implementations, tables can also comprise other types of separation lines in addition to row and column separation lines.

### Cell Mering and Classification

The cell processing module 230 at least determines the structure of the table, that is, the layout of cells, based on the predicted row separation lines 203 and the predicted column separation lines 204. In some implementations, the cell processing module 230 may implement pixel-based processing in order to determine the layout of cells.

In some implementations, the cell processing module 230 may implement cell-based processing. FIG. 5 shows an example architecture of a cell processing module 230 implemented in accordance with some of the present disclosure. As shown in FIG. 5, the image 101 can be divided into a plurality of cells 501, 502, 503, 504, and so on, for example, according to the predicted row separation lines 203 and the predicted column separation lines 204. When the upper boundary line, the lower boundary line and the centerline are predicted for the row and column separation lines, the centerline can be used to divide the image 101.

The feature alignment module 510 generates a cell feature map 511. Each feature in the cell feature map 511 corresponds to one of the plurality of cells of the image 101. For example, feature 513 corresponds to cell 504. Assuming that the image 101 is divided into N×M cells, the cell feature map 511 comprises N×M feature vectors. The feature alignment module 510 may generate the cell feature map 511 in any suitable method.

As an example, for each cell, the feature alignment module 510 can apply the region of interest (ROI) alignment algorithm to extract a feature sub-map from the feature map 415 based on the cell's bounding box. Merely as an example without suggesting any limitations on the scope of the present disclosure, the size of the feature sub-map may be 7×7×C, for example. The extracted feature sub-maps can be fed to the Multi Layer Perception (MLP) network. Each layer of the MLP network has T (e.g., 512) nodes to generate a T-dimensional feature vector to represent the cell.

Further, the layout of cells in the table may be determined based on the cell feature map 511. The layout of cells may comprise the span range of individual cells in the image 101 (e. g., the span in the row direction and the column direction), the relative positions of different cells, and the like. To this end, in some implementations, it is possible to determine whether there are N×M cells to be merged in cells. As shown in FIG. 5, the feature enhancement module 520 generates an enhanced cell feature map 512 based on the cell feature map 511 to capture a wider range of context information.

The feature enhancement module 520 may be implemented with any suitable network. For example, the feature enhancement module 520 may comprise a plurality of parallel branches, and each branch may comprise the maximum pooling layer at the row level, the maximum pooling layer at the column level, and the convolution layer.

The cell merging module 530 determines whether there are adjacent cells to be merged among N×M cells based on the cell feature map 511 or the enhanced cell feature map 512. In the recognition result 102, some adjacent cells are merged. For example, cells 501, 502, and 503 are merged. In this way, the layout of the cells in the table is determined.

In some implementations, the cell merging module 530 may be implemented using a relational network. In the relational network, for each pair of adjacent cells, the features of the pair of adjacent cells can be spliced with the spatial compatibility features. The spliced features can be input into the binary classifier to predict whether the two cells are merged. Binary classifiers may comprise, for example, MLP networks and activation functions. In other implementations, other suitable networks may be used to implement the cell merging module 530. For example, a graph convolutional network (GCN) can be used. Cells can be considered nodes in the graph. The scope of this disclosure is not limited in this respect.

In this implementation, cells can be effectively and accurately merged by using the cell feature map instead of the pixel-based feature map. In addition, this also reduces the amount of computation.

Additionally, in some implementations, cell processing module 230 may comprise cell classification module 540. The cell processing module 230 may determine the type of content filled in the cell according to the cell feature map 511 or the enhanced cell feature map 512. For example, you can determine whether the content filled in a cell belongs to the row header, column header, or data item. The cell classification module 540 may be implemented with any suitable network. For example, the cell classification module 540 may comprise an MLP network and a Softmax activation function. Further, in some implementations, the text in the image 101 can also be recognized, and the text features can be generated using a language processing model. Accordingly, the cell processing module 230 may combine the cell feature map 511 or the enhanced cell feature map 512 with the text feature to predict the type of content filled in the cell.

In this implementation, the recognition result 102 may indicate the type of cell in addition to indicating the layout of the cell.

### Model Training

An example of training the separation line prediction module and the cell processing module in the model training system 110 will be described below. Take the separation line prediction module 221 for predicting the row separation line as an example to describe the loss function for the separation line prediction module.

The loss function L_{ref}^{row} for training the reference point detection module 310 can be determined by the following equation:

$${L}_{ref}^{row} = - \frac{1}{{N}_{r}} {\sum }_{i = 1}^{H} \{ \begin{matrix}{( 1 - {𝓅}_{i} )}^{α} log ( {𝓅}_{i} ) , & {𝓅}_{i}^{*} = 1 \\ {( 1 - {𝓅}_{i}^{*} )}^{β} {𝓅}_{i}^{α} log ( 1 - {𝓅}_{i} ) , & otherwise\end{matrix} \qquad ( 1 )$$

Where Nᵣ is the number of row separation lines, α and β are super parameters, Pᵢ and Pᵢ^{*} are respectively the prediction tag and truth tag of the i-th pixel in the reference pixel block at x_{τ} (whether they are on the row separation line). (yₖ, x_{τ}) is used to represent the true value reference point for the k-th row separation line, which is the intersection point x=x_{τ} of the centerline of the row separation line and the vertical line. The vertical distance between the upper boundary line and the lower boundary line of the k-th row separation line is considered as the thickness of the kth row separation line, which is recorded as wₖ. Then, Pᵢ^{*} can be defined as below:

$${𝓅}_{i}^{*} = \{ \begin{matrix}exp ( - \frac{{( i - {y}_{k} )}^{2}}{2 {σ}_{k}^{2}} ) , & if i ∈ ( {y}_{k} - \frac{{w}_{k}}{2} , {y}_{k} + \frac{{w}_{k}}{2} ) \\ 0 , & otherwise\end{matrix} \qquad ( 2 )$$

where

$${σ}_{k} = \sqrt{\frac{{w}_{k}^{2}}{2 ln ( 10 )}}$$

is applicable to the thickness of the separation lines to ensure that the value of Pᵢ^{*} within this row separation line is less than 0.1.

The loss function for training the separation line regression module 320 may be expressed as

$${L}_{line}^{row} .$$

y={cᵢ,lᵢ)|i=1, . . . , M} represents a set of truth value row separation lines, where cᵢ and lᵢ represent the position of the target classification and row separation line, respectively.

$${y}^{*} = \{ ( {c}_{k}^{*} , {l}_{k}^{*} ) \vert k = 1 , … , Q \}$$

represents a set of predicted row separation lines. In some implementations, in order to accelerate the convergence of the model, the loss is computed by pairing the row reference point with the truth value row separation line closest to the reference point, rather than pairing the row predicted separation line obtained from the row reference point with the truth value predicted separation line. In this implementation, after obtaining the oldest matching result \hat{σ} between the line reference point and the truth line spacing line, the loss function for training the separation line regression module 320 can be determined as:

$${L}_{line}^{row} = {\sum }_{i = 1}^{Q} [ {L}_{cls} ( {c}_{i} , {c}_{\hat{σ} ( i )}^{*} ) + {1}_{\{ {c}_{i} \neq ∅ \}} {L}_{reg} ( {l}_{i} , {l}_{\hat{σ} ( i )}^{*} ) ] \qquad ( 3 )$$

where L_{cls} is focus loss and L_{reg} is L1 loss

In the training phase of the model, auxiliary branches parallel to the separation line prediction module 221 can be added. The auxiliary branch is used to predict whether each pixel is within the range of any row separation line. The secondary branch thus generates the mask M_{row}∈R^{H×W×1}. The auxiliary loss of row separation line

$${L}_{aux}^{row}$$

is the binary cross entropy loss as follows:

$${L}_{aux}^{row} = \frac{1}{\vert {S}_{row} \vert} {\sum }_{( x , y ) ∈ {S}_{row}} BCE ( {M}_{row} ( x , y ) , {M}_{row}^{*} ( x , y ) ) \qquad ( 4 )$$

where S_{row} represents a set of pixels sampled from M_{row}, and M_{row} and

$${M}_{row}^{*} ( x , y )$$

represent the prediction tag and truth tag of the pixels in S_{row}, respectively.

$${M}_{row}^{*} ( x , y )$$

is 1 only if the pixel is on the line separation line; otherwise it is 0.

The loss L_{merge} of cell processing module 230 is the binary cross entropy loss as follows:

$${L}_{merge} = \frac{1}{\vert {S}_{rel} \vert} {\sum }_{i ∈ {S}_{rel}} BCE ( {P}_{i} , {P}_{i}^{*} ) \qquad ( 5 )$$

where Sᵣₑₗ represents a set of sampled relative cell pairs, and Pᵢ and Pᵢ^{*} represent the prediction tag and truth tag for the i-th cell pair, respectively.

Likewise, it can be determined that in the case of the predicted row separation lines and the column separation lines as shown in FIG. 2, the total loss L is as follows:

$$L = λ ( {L}_{ref}^{row} + {L}_{ref}^{col} ) + {L}_{aux}^{row} + {L}_{aux}^{col} + {L}_{line}^{row} + {L}_{line}^{col} + {L}_{merge} \qquad ( 6 )$$

where

$${L}_{*}^{col}$$

represents the loss of the column separation line of the same kind as the loss of the row separation line.

It is to be understood that the losses described above are only example and are not intended to limit the scope of the present disclosure. The corresponding losses may be used according to the implementation of the table identification model 105.

### Sample Process

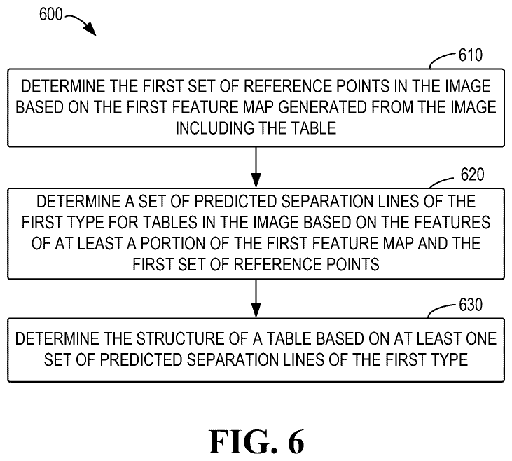

FIG. 6 shows a flowchart of a process 600 of identifying tabular results according to some implementations of the present disclosure. Process 600 may be implemented at model application system 120 of FIG. 1.

At block 610, the model application system 120 determines the first set of reference points in the image 101 based on the first feature map generated from the image 101 including the table. The first set of reference points are candidates on the separation lines of the first type of the table. In some implementations, the separation lines of the first type are row separation lines or column separation lines. If the separation lines of the first type are row separation lines, the first feature map may be the feature map 201. If the separation lines of the first type are column separation lines, the first feature map may be the feature map 202.

In some implementations, in order to determine the first set of reference points, the model application system 120 can extract features of the reference pixel block of an image from the first feature map, and the reference pixel block is sampled in a direction perpendicular to the predetermined direction of the separation lines of the first type. That is, the reference pixel block may extend in a direction perpendicular to the predetermined direction of the separation lines of the first type. The model application system 120 may select a set of pixels in the reference pixel block as the first set of reference points based on the features of the reference pixel block. Where the separation lines of the first type are row separation lines, the reference pixel block may be all pixels at x_{τ}. Where the separation lines of the first type are column separation lines, the reference pixel block may be all pixels at y_{τ}.

At block 620, the model application system 120 determines a set of predicted separation lines of the first type for tables in the image 101 based on the features of at least a portion of the first feature map and the first set of reference points. For example, the model application system 120 may determine a set of predicted row separation lines 203 or a set of predicted column separation lines 204.

In some implementations, in order to determine a set of predicted separation lines of the first type, the model application system 120 can extract the sampled features of the image 101 from the first feature map. The model application system 120 can determine the predicted pixels located on the separation lines of the first type in the image 101 based on the sampled features of the image 101 and the features of the first set of reference points. The model application system 120 may determine a set of predicted separation lines of the first type based on the position of the predicted pixel in the image 101.

In some implementations, in order to extract the sampled features of the image 101 from the first feature map, the model application system 120 can extract features of a plurality of pixel blocks of the image from the first feature map. The plurality of pixel blocks are spaced along a predetermined direction of the separation lines of the first type, and each pixel block is sampled in a direction perpendicular to the predetermined direction. That is, each pixel block may extend in a direction perpendicular to a predetermined direction.

In some implementations, in order to determine the predicted pixel, the model application system 120 can update the features of the first set of reference points based on the sampled features of the image 101 and the features of the first set of reference points. The updated features of the reference point reflect the correlation between the reference point and each pixel in the sampled part of the image. The model application system 120 may select reference points from the first set of reference points based on the updated features of the first set of reference points. The model application system 120 may determine a predicted pixel based on the updated features of the selected reference point.

At block 630, the model application system 120 determines the structure of a table based on at least one set of predicted separation lines of the first type.

In some implementations, in order to determine the structure of the table, the model application system 120 can divide at least a part of the image into a plurality of cells according to at least a set of predicted separation lines of the first type. The model application system 120 can generate a cell feature map of the plurality of cells, and one feature in the cell feature map corresponds to one of the plurality of cells. The model application system 120 can determine the layout of cells in the table based on the cell feature map. The layout may comprise the span of individual cells in a predetermined direction (e. g., row direction and column direction), the relative positions of different cells, and the like.

In some implementations, the model application system 120 can also determine the type of content filled by cells in the plurality of cells based on the cell feature map. Additionally, the type of content can be further determined based on the text features of the text in the image.

In some implementations, the model application system 120 can also predict the second type of separation line similarly to the separation lines of the first type. To this end, the model application system 120 may determine a second set of reference points in the image based on the second feature map generated from the image. The second set of reference points is a candidate point on the second type of separation line of the table, which is different from the separation lines of the first type. The model application system 120 may determine a set of predicted separation lines of the second type of the table in the image based on the features of at least a part of the second feature map and the second set of reference points. Further, the model application system 120 can determine the structure of the table based on a set of first type predicted separation lines and a set of second type predicted separation lines.

In some implementations, the model application system 120 can also generate a third feature map based on the image, and divide the third feature map into a series of feature sub-maps along the predetermined direction of the separation lines of the first type. The model application system 120 can also update a series of feature sub-maps by performing feature transformation for extracting context information on a series of feature sub-maps in the opposite direction of a predetermined direction and a predetermined direction. For example, the feature transformation may comprise a convolution operation or an attention mechanism. The model application system 120 can also combine a series of updated feature sub-maps into a first feature map.

In some implementations, in order to update a series of feature sub-maps in turn, the model application system 120 may perform feature transformation on the first feature sub-map in a series of feature sub-maps. The model application system 120 may update the second feature sub-map based on the transformed features of the first feature sub-map, and the second feature sub-map is located after the first feature sub-map in one of the predetermined directions or the opposite directions. The model application system 120 may perform feature transformation on the updated second feature sub-map. The model application system 120 may update the third feature sub-map following the second feature sub-map in this direction based on the transformed features of the updated second feature sub-map.

### Sample Device

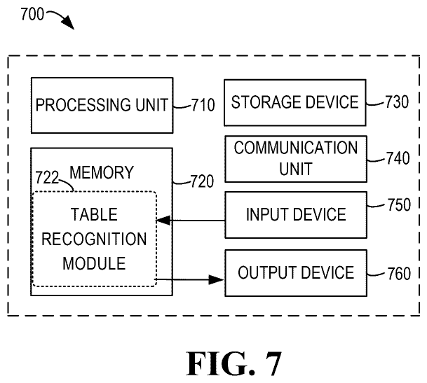

FIG. 7 shows a schematic block diagram of an electronic device capable of implementing various implementations of the present disclosure. It is to be understood that the electronic device 700 shown in FIG. 7 is only example and should not constitute any limitation on the function and scope of the implementation described in the present disclosure.

As shown in FIG. 7, the electronic device 700 comprises an electronic device 700 in the form of a general-purpose computing device. The components of electronic device 700 may comprise, but are not limited to, one or more processors or processing units 710, memory 720, storage devices 730, one or more communication units 740, one or more input devices 750, and one or more output devices 760.

In some implementations, the electronic device 700 can be implemented as a computing device, computing system, server, mainframe, and other computing capable devices.

The processing unit 710 can be an actual or virtual processor and can perform various processes according to the programs stored in the memory 720. In a multiprocessor system, a plurality of processing units executes computer executable instructions in parallel to improve the parallel processing capability of electronic device 700. The processing unit 710 may comprise a central processing unit (CPU), a graphics processing unit (GPU), a microprocessor, a controller, and/or a microcontroller.

The electronic device 700 typically comprises a plurality of computer storage media. Such media may be any available media accessible to electronic device 700, including but not limited to volatile and non-volatile media, removable and non removable media. The memory 720 may comprise volatile memory (such as registers, cache, random access memory (RAM)), non-volatile memory (such as read-only memory (ROM), electrically erasable programmable read-only memory (EEPROM), flash memory), or some combination thereof. The storage device 730 may comprise removable or non-removable media, and may comprise computer-readable media such as memory, flash drives, disks, or any other media that can be used to store information and/or data and can be accessed within the electronic device 700.

The electronic device 700 may further comprise additional removable/non removable, volatile/non-volatile storage media. Although not shown in FIG. 7, a disk drive for reading or writing from a removable, nonvolatile disk and an optical disk drive for reading or writing from a removable, nonvolatile optical disk may be provided. In these cases, each drive may be connected to a bus (not shown) by one or more data medium interfaces.

The communication unit 740 realizes communication with another computing device through a communication medium. Additionally, the functions of the components of the electronic device 700 can be implemented in a single computing cluster or a plurality of computing machines that can communicate through a communication connection. Therefore, electronic device 700 can operate in a networked environment using a logical connection to one or more other servers, personal computers (PCs), or another general network node.

The input device 750 may be one or more various input devices, such as a mouse, a keyboard, a data import device, and the like. The output device 760 may be one or more output devices, such as a display, a data export device, and the like. The electronic device 700 can also communicate with one or more external devices (not shown) through the communication unit 740 as required, such as storage devices, display devices, etc., with one or more devices that enable users to interact with the electronic device 700, or with any device (such as network cards, modems, etc.) that enables the electronic device 700 to communicate with one or more other computing devices. Such communication may be performed via an input/output (I/O) interface (not shown).

In some implementations, in addition to being integrated on a single device, some or all of the components of the electronic device 700 may also be set in the form of a cloud computing architecture. In the cloud computing architecture, these components can be remotely arranged and can work together to implement the functions described in the present disclosure. In some implementations, cloud computing provides computing, software, data access and storage services, which do not require the end user to know the physical location or configuration of the system or hardware providing these services. In various implementations, cloud computing uses appropriate protocols to provide services over a wide area network, such as the internet. For example, cloud computing providers provide applications over a wide area network, and they can be accessed through a web browser or any other computing component. The software or component of cloud computing architecture and corresponding data can be stored on the server at a remote location. Computing resources in a cloud computing environment can be combined at remote data center locations or they can be dispersed. Cloud computing infrastructure can provide services through shared data centers, even if they represent a single point of access for users. Therefore, the components and functions described herein can be provided from a service provider at a remote location using a cloud computing architecture. Alternatively, they may be provided from a conventional server, or they may be installed directly or otherwise on a client device.

The electronic device 700 may be used to implement resource management in various implementations of the present disclosure. The memory 720 may comprise one or more modules having one or more program instructions, which may be accessed and run by the processing unit 760 to implement various implemented functions described herein. For example, the memory 720 may comprise a table recognition module 725 for determining the structure of a table in an image. As shown in FIG. 7, the electronic device 700 can acquire the image 101 through the input device 750, and can provide the recognition result 102 through the output device 760. In some implementations, the electronic device 700 may also receive input from other devices (not shown) via the communication unit 740.

### Example Implementations

Some example implementations of this disclosure are listed below.

In one aspect, the present disclosure provides a computer implementation method. The method comprises: determining, based on a first feature map generated from an image including a table, a first set of reference points in the image, the first set of reference points being candidate points on separation lines of a first type of the table; determining, based on at least a part of the first feature map and features of the first set of reference points, a set of predicted separation lines of the first type for the table from the image; and determine a structure of the table based at least on the set of predicted separation lines of the first type.

In some example implementations, the first set of reference points are distributed in a direction perpendicular to a predetermined direction of the separation lines of the first type.

In some example implementations, determining the set of predicted separation lines of the first type comprises: extracting sampled features of the image from the first feature map; determining, based on the sampled features of the image and the features of the first set of reference points, predicted pixels in the image located on the separation lines of the first type; and determining the set of predicted separation lines of the first type based on positions of the predicted pixel in the image.

In some example implementations, determining the predicted pixels comprises: updating the features of the first set of reference points based on the sampled features of the image and the features of the first set of reference points, wherein the updated features of a reference point reflect a correlation between the reference point and individual pixels in a sampling portion of the image; selecting reference points from the first set of reference points based on the updated features of the first set of reference points; and determining the predicted pixels based on the updated features of the selected reference points.

In some example implementations, extracting the sampled feature of the image comprises: extracting features of a plurality of pixel blocks of the image from the first feature map, the plurality of pixel blocks spaced along a predetermined direction of the separation lines of the first type, each pixel block being sampled in a direction perpendicular to the predetermined direction.

In some example implementations, determining the first set of reference points comprises: extracting features of a reference pixel block of the image from the first feature map, the reference pixel block being sampled in a direction perpendicular to a predetermined direction of the separation lines of the first type; and selecting a set of pixels from the reference pixel block based on the features of the reference pixel block as the first set of reference points.

In some example implementations, determining the structure of the table comprises: dividing at least a part of the image into a plurality of cells based at least on the set of predicted separation lines of the first type; generating a cell feature map for the plurality of cells, a feature from the cell feature map corresponding to one of the plurality of cells; and determining a layout of the cells in the table based on the cell feature map.

In some example implementations, the method further comprises: determining, based on the cell feature map, a type of content filled in cells in the plurality of cells.

In some example implementations, determining the structure of the table comprises: determining, based on a second feature map generated from the image, a second set of reference points in the image, the second set of reference points being candidate points on separation lines of a second type of the table, the separation lines of the second type being different from the separation lines of the first type; determining a set of predicted separation lines of the second type of the table in the image based on at least a part of the second feature map features of the second set of reference points; and determining the structure of the table based on the set of predicted separation lines of the first type and the set of predicted separation lines of the second type.

In some example implementations, the method further comprises: generating a third feature map from the image; dividing the third feature map into a series of feature sub-maps along a predetermined direction of the separation lines of the first type; updating the series of feature sub-maps by applying a feature transformation for extracting context information on the series of feature sub-maps in accordance with the predetermined direction and an opposite direction of the predetermined direction; and combining the updated series of feature sub-maps into the first feature map.

In some example implementations, updating the series of feature sub-maps comprises: applying a feature transformation on a first feature sub-map of the series of feature sub-maps; updating a second feature sub-map based on the transformed features of the first feature sub-map, the second feature sub-map located after the first feature sub-map in a direction which is one of the predetermined direction or the opposite direction; applying a feature transformation on the updated second feature sub-map; and updating a third feature sub-map after the second feature sub-map in the direction based on the transformed features of the updated second feature sub-map.

In some example implementations, the separation lines of the first type are row separation lines or column separation lines.

In another aspect, the present disclosure provides an electronic device. The electronic device comprises a processor; and a memory, coupled to the processor and containing instructions stored thereon, which, when executed by the processor, causes the device to perform acts comprising: determining, based on a first feature map generated from an image including a table, a first set of reference points in the image, the first set of reference points being candidate points on separation lines of a first type of the table; determining, based on at least a part of the first feature map and features of the first set of reference points, a set of predicted separation lines of the first type for the table from the image; and determine a structure of the table based at least on the set of predicted separation lines of the first type.

In some example implementations, the first set of reference points are distributed in a direction perpendicular to a predetermined direction of the separation lines of the first type.

In some example implementations, determining the set of predicted separation lines of the first type comprises: extracting sampled features of the image from the first feature map; determining, based on the sampled features of the image and the features of the first set of reference points, predicted pixels in the image located on the separation lines of the first type; and determining the set of predicted separation lines of the first type based on positions of the predicted pixel in the image.

In some example implementations, determining the predicted pixels comprises: updating the features of the first set of reference points based on the sampled features of the image and the features of the first set of reference points, wherein the updated features of a reference point reflect a correlation between the reference point and individual pixels in a sampling portion of the image; selecting reference points from the first set of reference points based on the updated features of the first set of reference points; and determining the predicted pixels based on the updated features of the selected reference points.

In some example implementations, extracting the sampled feature of the image comprises: extracting features of a plurality of pixel blocks of the image from the first feature map, the plurality of pixel blocks spaced along a predetermined direction of the separation lines of the first type, each pixel block being sampled in a direction perpendicular to the predetermined direction.

In some example implementations, determining the first set of reference points comprises: extracting features of a reference pixel block of the image from the first feature map, the reference pixel block being sampled in a direction perpendicular to a predetermined direction of the separation lines of the first type; and selecting a set of pixels from the reference pixel block based on the features of the reference pixel block as the first set of reference points.

In some example implementations, determining the structure of the table comprises: dividing at least a part of the image into a plurality of cells based at least on the set of predicted separation lines of the first type; generating a cell feature map for the plurality of cells, a feature from the cell feature map corresponding to one of the plurality of cells; and determining a layout of the cells in the table based on the cell feature map.

In some example implementations, the acts further comprise: determining, based on the cell feature map, a type of content filled in cells in the plurality of cells.

In some example implementations, determining the structure of the table comprises: determining, based on a second feature map generated from the image, a second set of reference points in the image, the second set of reference points being candidate points on separation lines of a second type of the table, the separation lines of the second type being different from the separation lines of the first type; determining a set of predicted separation lines of the second type of the table in the image based on at least a part of the second feature map features of the second set of reference points; and determining the structure of the table based on the set of predicted separation lines of the first type and the set of predicted separation lines of the second type.

In some example implementations, the acts further comprise: generating a third feature map from the image; dividing the third feature map into a series of feature sub-maps along a predetermined direction of the separation lines of the first type; updating the series of feature sub-maps by applying a feature transformation for extracting context information on the series of feature sub-maps in accordance with the predetermined direction and an opposite direction of the predetermined direction; and combining the updated series of feature sub-maps into the first feature map.

In some example implementations, updating the series of feature sub-maps comprises: applying a feature transformation on a first feature sub-map of the series of feature sub-maps; updating a second feature sub-map based on the transformed features of the first feature sub-map, the second feature sub-map located after the first feature sub-map in a direction which is one of the predetermined direction or the opposite direction; applying a feature transformation on the updated second feature sub-map; and updating a third feature sub-map after the second feature sub-map in the direction based on the transformed features of the updated second feature sub-map.

In some example implementations, the separation lines of the first type are row separation lines or column separation lines.

In yet another aspect, the present disclosure provides a computer program product. The computer program product is tangibly stored in a computer storage medium and comprises computer executable instructions. When the computer executable instructions are executed by the device, the device performs the acts comprising: determining, based on a first feature map generated from an image including a table, a first set of reference points in the image, the first set of reference points being candidate points on separation lines of a first type of the table; determining, based on at least a part of the first feature map and features of the first set of reference points, a set of predicted separation lines of the first type for the table from the image; and determine a structure of the table based at least on the set of predicted separation lines of the first type.

In some example implementations, the first set of reference points are distributed in a direction perpendicular to a predetermined direction of the separation lines of the first type.

In some example implementations, determining the set of predicted separation lines of the first type comprises: extracting sampled features of the image from the first feature map; determining, based on the sampled features of the image and the features of the first set of reference points, predicted pixels in the image located on the separation lines of the first type; and determining the set of predicted separation lines of the first type based on positions of the predicted pixel in the image.

In some example implementations, determining the predicted pixels comprises: updating the features of the first set of reference points based on the sampled features of the image and the features of the first set of reference points, wherein the updated features of a reference point reflect a correlation between the reference point and individual pixels in a sampling portion of the image; selecting reference points from the first set of reference points based on the updated features of the first set of reference points; and determining the predicted pixels based on the updated features of the selected reference points.

In some example implementations, extracting the sampled feature of the image comprises: extracting features of a plurality of pixel blocks of the image from the first feature map, the plurality of pixel blocks spaced along a predetermined direction of the separation lines of the first type, each pixel block being sampled in a direction perpendicular to the predetermined direction.

In some example implementations, determining the first set of reference points comprises: extracting features of a reference pixel block of the image from the first feature map, the reference pixel block being sampled in a direction perpendicular to a predetermined direction of the separation lines of the first type; and selecting a set of pixels from the reference pixel block based on the features of the reference pixel block as the first set of reference points.

In some example implementations, determining the structure of the table comprises: dividing at least a part of the image into a plurality of cells based at least on the set of predicted separation lines of the first type; generating a cell feature map for the plurality of cells, a feature from the cell feature map corresponding to one of the plurality of cells; and determining a layout of the cells in the table based on the cell feature map.

In some example implementations, the acts further comprise: determining, based on the cell feature map, a type of content filled in cells in the plurality of cells.

In some example implementations, determining the structure of the table comprises: determining, based on a second feature map generated from the image, a second set of reference points in the image, the second set of reference points being candidate points on separation lines of a second type of the table, the separation lines of the second type being different from the separation lines of the first type; determining a set of predicted separation lines of the second type of the table in the image based on at least a part of the second feature map features of the second set of reference points; and determining the structure of the table based on the set of predicted separation lines of the first type and the set of predicted separation lines of the second type.

In some example implementations, the acts further comprise: generating a third feature map from the image; dividing the third feature map into a series of feature sub-maps along a predetermined direction of the separation lines of the first type; updating the series of feature sub-maps by applying a feature transformation for extracting context information on the series of feature sub-maps in accordance with the predetermined direction and an opposite direction of the predetermined direction; and combining the updated series of feature sub-maps into the first feature map.

In some example implementations, updating the series of feature sub-maps comprises: applying a feature transformation on a first feature sub-map of the series of feature sub-maps; updating a second feature sub-map based on the transformed features of the first feature sub-map, the second feature sub-map located after the first feature sub-map in a direction which is one of the predetermined direction or the opposite direction; applying a feature transformation on the updated second feature sub-map; and updating a third feature sub-map after the second feature sub-map in the direction based on the transformed features of the updated second feature sub-map.

In some example implementations, the separation lines of the first type are row separation lines or column separation lines.

In still yet another aspect, the present disclosure provides a computer-readable medium on which computer executable instructions are stored, which, when executed by a device, causes the device to execute one or more examples of the methods in the above aspects.

The functions described above herein may be performed at least partially by one or more logic units. For example, non limiting, example types of hardware logic components that can be used comprise: field programmable gate array (FPGA), application specific integrated circuit (ASIC), application specific standard product (ASSP), system on chip (SOC), load programmable logic device (CPLD), and so on.

The program code for implementing the method of the present disclosure can be written in any combination of one or more programming languages. These program codes can be provided to a processor or controller of a general purpose computer, a special purpose computer or other programmable data processing device, so that when the program code is executed by a processor or controller, the functions/operations specified in the flow chart and/or block diagram are implemented. The program code can be executed completely on the machine, partially on the machine, partially on the machine as an independent software package and partially on a remote machine or completely on a remote machine or server.

In the context of the present disclosure, a machine-readable medium may be a tangible medium, which may contain or store programs for use by or in combination with an instruction execution system, device or device. The machine-readable medium may be a machine-readable signal medium or a machine-readable storage medium. Machine-readable media may comprise, but are not limited to, electronic, magnetic, optical, electromagnetic, infrared, or semiconductor systems, devices, or devices, or any suitable combination of the foregoing. A more specific example of a machine-readable storage medium would comprise an electrical connection based on one or more lines, a portable computer disk, a hard disk, random access memory (RAM), read-only memory (ROM), erasable programmable read-only memory (EPROM or flash memory), optical fiber, portable compact disk read-only memory (CD-ROM), optical storage device, magnetic storage device, or any suitable combination of the above.

In addition, although the operations are described in a particular order, it is to be understood that such operations are required to be performed in a particular order shown or in a sequential order, or that all illustrated operations should be performed to obtain a desired result. Under certain circumstances, multitasking and parallel processing may be beneficial. Similarly, although the above discussion contains a number of specific implementation details, these should not be interpreted as limiting the scope of the disclosure. Some features described in the context of a separate implementation can also be implemented in a single implementation in combination. Conversely, various features described in the context of a single implementation can also be implemented in a plurality of implementations individually or in any suitable sub combination.

Although the subject matter has been described in terms specific to the structural features and/or method logic actions, it is to be understood that the subject matter defined in the appended claims is not necessarily limited to the specific features or actions described above. On the contrary, the specific features and actions described above are only examples of realizing the claims.

1-15. (canceled)

16. A computer-implementation method comprising:
determining, based on a first feature map generated from an image including a table, a first set of reference points in the image, the first set of reference points being candidate points on separation lines of a first type of the table;
determining, based on at least a part of the first feature map and features of the first set of reference points, a set of predicted separation lines of the first type for the table from the image; and
determine a structure of the table based at least on the set of predicted separation lines of the first type.

17. The method of claim 16, wherein the first set of reference points are distributed in a direction perpendicular to a predetermined direction of the separation lines of the first type.

18. The method of claim 16, wherein determining the set of predicted separation lines of the first type comprises:
extracting sampled features of the image from the first feature map;
determining, based on the sampled features of the image and the features of the first set of reference points, predicted pixels in the image located on the separation lines of the first type; and
determining the set of predicted separation lines of the first type based on positions of the predicted pixel in the image.

19. The method of claim 18, wherein determining the predicted pixels comprises:
updating the features of the first set of reference points based on the sampled features of the image and the features of the first set of reference points, wherein the updated features of a reference point reflect a correlation between the reference point and individual pixels in a sampling portion of the image;
selecting reference points from the first set of reference points based on the updated features of the first set of reference points; and
determining the predicted pixels based on the updated features of the selected reference points.

20. The method of claim 18, wherein extracting the sampled features of the image comprises:
extracting features of a plurality of pixel blocks of the image from the first feature map, the plurality of pixel blocks spaced along a predetermined direction of the separation lines of the first type, each pixel block being sampled in a direction perpendicular to the predetermined direction.

21. The method of claim 16, wherein determining the first set of reference points comprises:
extracting features of a reference pixel block of the image from the first feature map, the reference pixel block being sampled in a direction perpendicular to a predetermined direction of the separation lines of the first type; and
selecting a set of pixels from the reference pixel block based on the features of the reference pixel block as the first set of reference points.

22. The method of claim 16, wherein determining the structure of the table comprises:
dividing at least a part of the image into a plurality of cells based at least on the set of predicted separation lines of the first type;
generating a cell feature map for the plurality of cells, a feature from the cell feature map corresponding to one of the plurality of cells; and
determining a layout of the cells in the table based on the cell feature map.

23. The method of claim 22, further comprising:
determining, based on the cell feature map, a type of content filled in cells in the plurality of cells.

24. The method of claim 16, wherein determining the structure of the table comprises:
determining, based on a second feature map generated from the image, a second set of reference points in the image, the second set of reference points being candidate points on separation lines of a second type of the table, the separation lines of the second type being different from the separation lines of the first type;
determining a set of predicted separation lines of the second type of the table in the image based on at least a part of the second feature map features of the second set of reference points; and
determining the structure of the table based on the set of predicted separation lines of the first type and the set of predicted separation lines of the second type.

25. The method of claim 16, further comprising:
generating a third feature map from the image;
dividing the third feature map into a series of feature sub-maps along a predetermined direction of the separation lines of the first type;
updating the series of feature sub-maps by applying a feature transformation for extracting context information on the series of feature sub-maps in accordance with the predetermined direction and an opposite direction of the predetermined direction; and
combining the updated series of feature sub-maps into the first feature map.

26. The method of claim 25, wherein updating the series of feature sub-maps comprises:
applying a feature transformation on a first feature sub-map of the series of feature sub-maps;
updating a second feature sub-map based on the transformed features of the first feature sub-map, the second feature sub-map located after the first feature sub-map in a direction which is one of the predetermined direction or the opposite direction;
applying a feature transformation on the updated second feature sub-map; and
updating a third feature sub-map after the second feature sub-map in the direction based on the transformed features of the updated second feature sub-map.

27. An electronic device, comprising:
a processing unit; and
a memory coupled to the processing unit and comprising instructions stored thereon, the instructions, when executed by the processing unit, causing the device to perform acts comprising:
determining, based on a first feature map generated from an image including a table, a first set of reference points in the image, the first set of reference points being candidate points on separation lines of a first type of the table;
determining, based on at least a part of the first feature map and features of the first set of reference points, a set of predicted separation lines of the first type for the table from the image; and
determine a structure of the table based at least on the set of predicted separation lines of the first type.

28. The device of claim 27, wherein the first set of reference points are distributed in a direction perpendicular to a predetermined direction of the separation lines of the first type.

29. The device of claim 27, wherein determining the set of predicted separation lines of the first type comprises:
extracting sampled features of the image from the first feature map;
determining, based on the sampled features of the image and the features of the first set of reference points, predicted pixels in the image located on the separation lines of the first type; and
determining the set of predicted separation lines of the first type based on positions of the predicted pixel in the image.

30. The device of claim 29, wherein determining the predicted pixels comprises:
updating the features of the first set of reference points based on the sampled features of the image and the features of the first set of reference points, wherein the updated features of a reference point reflect a correlation between the reference point and individual pixels in a sampling portion of the image;
selecting reference points from the first set of reference points based on the updated features of the first set of reference points; and
determining the predicted pixels based on the updated features of the selected reference points.

31. The device of claim 27, wherein determining the first set of reference points comprises:
extracting features of a reference pixel block of the image from the first feature map, the reference pixel block being sampled in a direction perpendicular to a predetermined direction of the separation lines of the first type; and
selecting a set of pixels from the reference pixel block based on the features of the reference pixel block as the first set of reference points.

32. The device of claim 27, wherein determining the structure of the table comprises:
dividing at least a part of the image into a plurality of cells based at least on the set of predicted separation lines of the first type;
generating a cell feature map for the plurality of cells, a feature from the cell feature map corresponding to one of the plurality of cells; and
determining a layout of the cells in the table based on the cell feature map.

33. The device of claim 32, the acts further comprising:
determining, based on the cell feature map, a type of content filled in cells in the plurality of cells.

34. The device of claim 27, wherein determining the structure of the table comprises:
determining, based on a second feature map generated from the image, a second set of reference points in the image, the second set of reference points being candidate points on separation lines of a second type of the table, the separation lines of the second type being different from the separation lines of the first type;
determining a set of predicted separation lines of the second type of the table in the image based on at least a part of the second feature map features of the second set of reference points; and
determining the structure of the table based on the set of predicted separation lines of the first type and the set of predicted separation lines of the second type.

35. A computer program product, comprising machine-executable instructions which, when executed by a device, cause the device to perform acts comprising:
determining, based on a first feature map generated from an image including a table, a first set of reference points in the image, the first set of reference points being candidate points on separation lines of a first type of the table;
determining, based on at least a part of the first feature map and features of the first set of reference points, a set of predicted separation lines of the first type for the table from the image; and
determine a structure of the table based at least on the set of predicted separation lines of the first type.
